(19) United States
(12) Patent Application Publication
(10) Pub. No.: US 2014/0287735 A1
(43) Pub. Date: Sep. 25, 2014

(54) PORTABLE TERMINAL, METHOD FOR MANAGING DATA IN PORTABLE TERMINAL, AND STORAGE MEDIUM STORING DATA MANAGEMENT PROCESSING PROGRAM

(71) Applicant: CASIO COMPUTER CO., LTD., Tokyo (JP)

(72) Inventor: Kazunori KITA, Tokyo (JP)

(73) Assignee: CASIO COMPUTER CO., LTD., Tokyo (JP)

(21) Appl. No.: 14/221,274

(22) Filed: Mar. 20, 2014

(30) Foreign Application Priority Data
Mar. 21, 2013 (JP) 2013-057978

(51) Int. Cl. H04W 8/22; H04W 52/02

(52) U.S. Cl. CPC H04W 8/22; H04W 52/0254
USPC 455/418

(57) ABSTRACT

A portable terminal includes: an activity delimiter condition storage unit in which a category of activity state data and an activity delimiter condition of the activity state data are stored, for each of categories of applications; a detection unit that detects the activity state data, for each of the categories of applications; an accumulation unit that accumulates the detected activity state data; a judgment unit that judges whether or not each piece of the activity state data accumulated by the accumulation unit matches the corresponding activity delimiter condition, on the basis of a detection result of the detection unit; and an activity accomplishment registration unit that registers, when the judgment unit judges that any one piece of the activity state data accumulated by the accumulation unit matches the corresponding activity delimiter condition, the one piece of activity state data accumulated by the accumulation unit as an activity accomplishment data.

### CROSS-REFERENCE TO RELATED APPLICATIONS

This application is based upon and claims the benefit of priority from the prior Japanese Patent Application No. 2013-057978 filed on Mar. 21, 2013, the entire contents of which are incorporated herein by reference.

### BACKGROUND OF THE INVENTION

1. Field of the Invention

The present invention relates to a portable terminal, a method for managing data in a portable terminal, and a storage medium which stores data management processing program.

2. Description of the Related Art

Heretofore, a portable terminal such as a wrist watch and a smartphone using a mini-size lithium rechargeable battery or the like sometimes transfers image data etc. contained therein to a personal computer, and/or transmits the image data etc. to an external server for data update therein or upload thereto. Meanwhile, there is also a case that the portable terminal downloads/receives a firmware for updating, etc. from a site of a manufacturer. Such processes are often performed, for example, when a user inputs an instruction, when the portable terminal itself operates intermittently/periodically/automatically, when the portable terminal is put on a cradle or the like so as to connect thereto, when the portable terminal is connected to a personal computer via a USB cable, and/or when wireless communication connection is established for the portable terminal by Wi-Fi, Bluetooth (registered trademark), etc.

However, in the portable terminal such as the wrist watch and the smartphone on which only a rechargeable battery having a small capacity can be loaded, the rechargeable battery drains out fast, namely, the charging capacity thereof drops drastically, when communications such as data transfer, data update, data transmission/upload, and data download/reception are frequently performed. Thus, there has been a problem that a battery available time is decreased, and/or a so-called “out of battery” state occurs and the portable cannot be used when a user actually wants to conduct a telephone call and/or a communication.

In view of such circumstances, there has been disclosed a technique, which is used in a wrist-wearable watch type portable terminal, to determine whether or not the portable terminal is being worn on a body, to enable communication only when the portable terminal is being worn on the body, and to restrict communication when the portable terminal is not being worn on the body (Japanese Patent Application Laid-Open Publication No. 2000-200315).

However, the technique of Japanese Patent Application Laid-Open Publication No. 2000-200315 merely controls an enabled/disabled state of communication depending on whether or not the portable terminal is being worn on the body, and the problem associated with communication such as decrease of the available time of the portable terminal, and so-called out of charge, cannot be solved when the portable terminal is being worn on the body.

An object of the present invention is mainly to provide a portable terminal that can reduce power consumption associated with communication, can save electricity, and can lengthen a battery life.

### SUMMARY OF THE INVENTION

The present invention is made in view of the above conventional circumstances, and provides a portable terminal including: an activity delimiter condition storage unit that stores a category of activity state data and an activity delimiter condition with respect to the activity state data, for each of a plurality of categories of applications; a detection unit that detects the activity state data of a user, for each of the plurality of categories of applications; an accumulation unit that accumulates the activity state data of the user detected by the detection unit; a judgment unit that judges whether or not a corresponding activity delimiter exists in the activity state data of each of the applications, on the basis of a detection result of the detection unit; and an activity accomplishment registration unit that registers, when the judgment unit judges that the corresponding activity delimiter exists in the activity state data of any of the applications, the activity state data of the any of the applications as an activity accomplishment data.

### BRIEF DESCRIPTION OF THE DRAWINGS

A more complete understanding of this application can be obtained when the following detailed description is considered in conjunction with the following drawings, in which:

FIG. 1A is a front view illustrating an exterior appearance of one example (wrist terminal) of a portable terminal;

FIG. 1B is a perspective view illustrating the exterior appearance of the one example (wrist terminal) of the portable terminal;

FIG. 2A is a front view illustrating an exterior appearance of another example (mobile phone) of the portable terminal;

FIG. 2B is a perspective view illustrating a usage state of the another example (mobile phone) of the portable terminal;

FIG. 3 is a block diagram illustrating a schematic configuration of the portable terminal;

FIG. 4 is a flowchart illustrating a flow of data management processing; and

FIG. 5 is a flowchart illustrating a flow of subsequent processing to FIG. 4.

### DETAILED DESCRIPTION OF THE INVENTION

Hereinafter, one example of embodiment of the present invention will be described in detail with reference to the attached drawings.

In this regard, however, the scope of the present invention is not limited to the illustrated example.

### [Configuration]

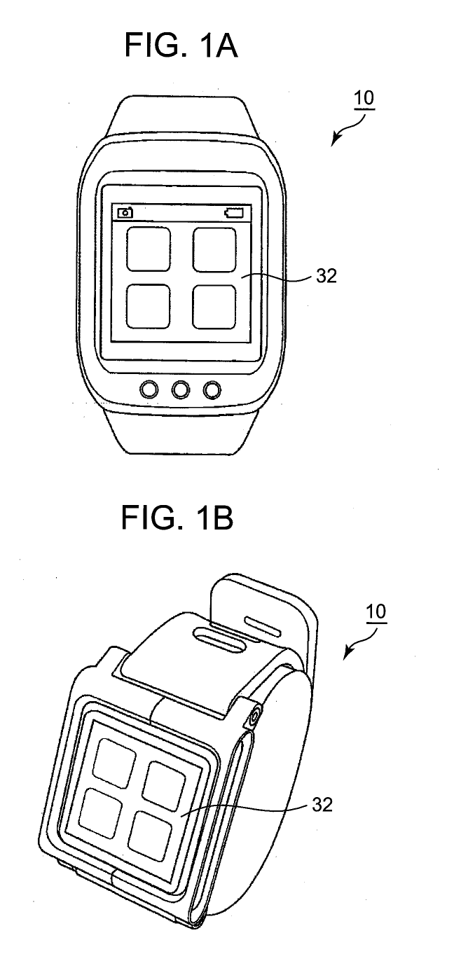

Each of FIGS. 1A and 1B illustrates an exterior appearance of a wrist terminal 10 to which a portable terminal of the present invention is applied to.

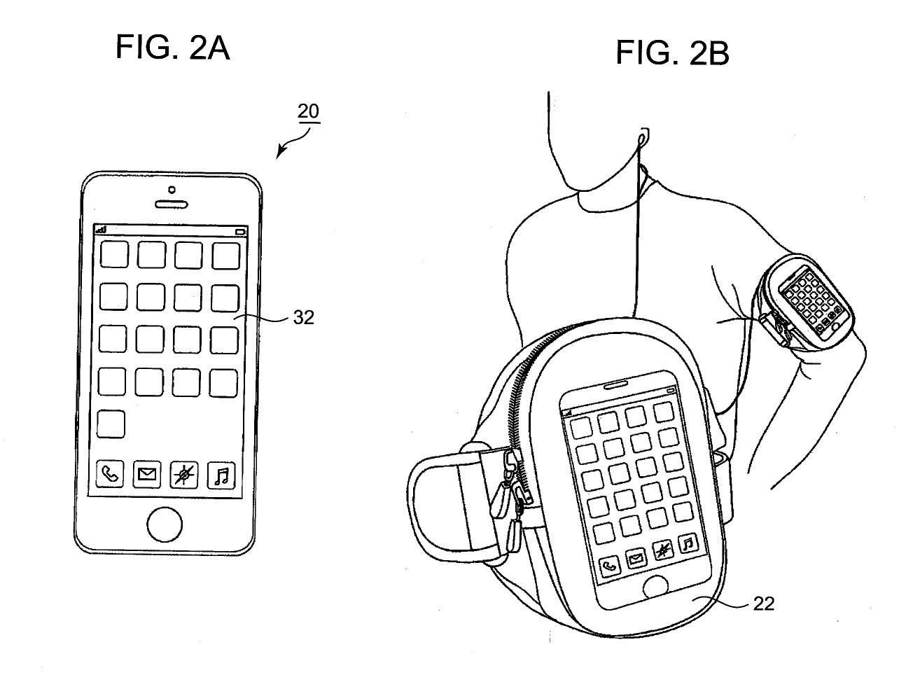

Each of FIGS. 2A and 2B illustrates an exterior appearance of a mobile phone 20 to which the portable terminal of the present invention is applied to.

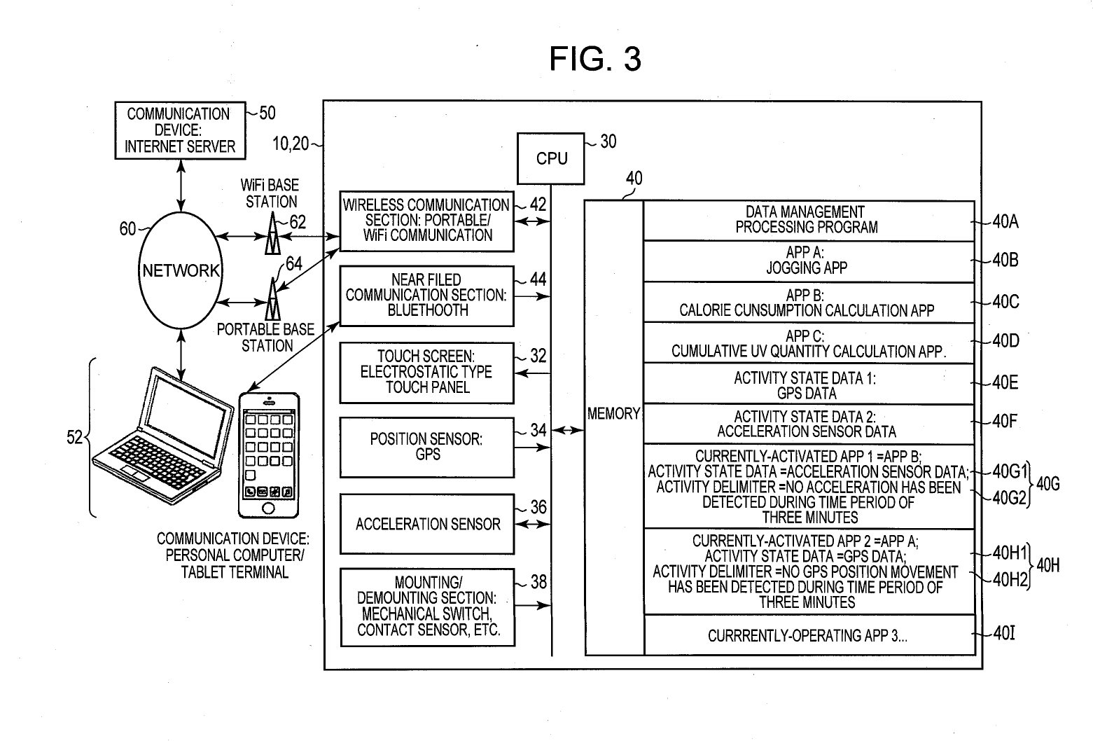

FIG. 3 is a block diagram illustrating a schematic configuration of the wrist terminal 10 or the mobile phone 20.

As illustrated in FIGS. 1A and 1B, the wrist terminal 10 has, for example, a wrist-wearable watch shape, and is worn on a wrist of a user.

As illustrated in FIGS. 2A and 2B, the mobile phone 20 has, for example, a flat plate shape, and is housed in a dedicated pouch 22 or the like to be worn on an arm of a user.

These wrist terminal 10 and mobile phone 20 have a common control configuration, and as illustrated in FIG. 3, each of them is configured to include a CPU 30, a touch screen 32, a position sensor 34, an acceleration sensor 36, a mounting/demounting detection section 38, a memory 40, a wireless communication section 42, a near field communication section 44, and so on.

The touch screen 32 is a so-called electrostatic type touch panel.

The touch screen 32 displays a key group for receiving inputs of characters or the like, outputs a signal corresponding to a kind and/or a position of each pressed key to the CPU 30, and displays various pieces of information on the basis of display signals input from the CPU 30.

The position sensor 34 is a so-called GPS sensor. The position sensor 34 is set to an ON state (conduction state) depending on an instruction by the CPU 30 and/or an operation by a user, and performs sensing operations.

The acceleration sensor 36 is a sensor which resolves acceleration applied to the wrist terminal 10 and/or the mobile phone 20 into components in three-axial directions to measure the acceleration. Also the acceleration sensor 36 is set to an ON state (conduction state) depending on an instruction by the CPU 30 and/or an operation by a user, and performs sensing operations.

The mounting/demounting detection section 38 is composed of a so-called mechanical switch, a contact sensor, or the like, and performs measurement to determine whether or not the wrist terminal 10 or the mobile phone 20 are worn on a user.

The memory 40 stores programs and/or data for conducting various functions of the wrist terminal 10 or the mobile phone 20, and functions as a work area of the CPU 30. In this embodiment, the memory 40 includes a data management processing program 40A. The memory 40 also stores various applications and the like, and accumulates detection results of the position sensor 34 and/or the acceleration sensor 36 therein.

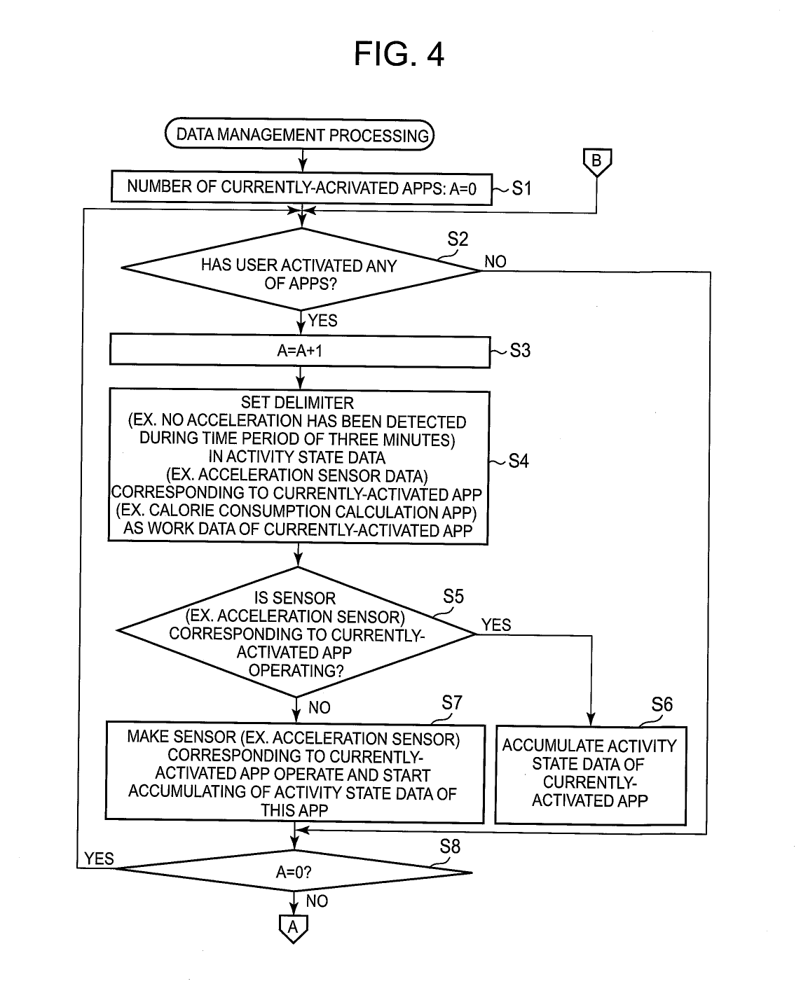

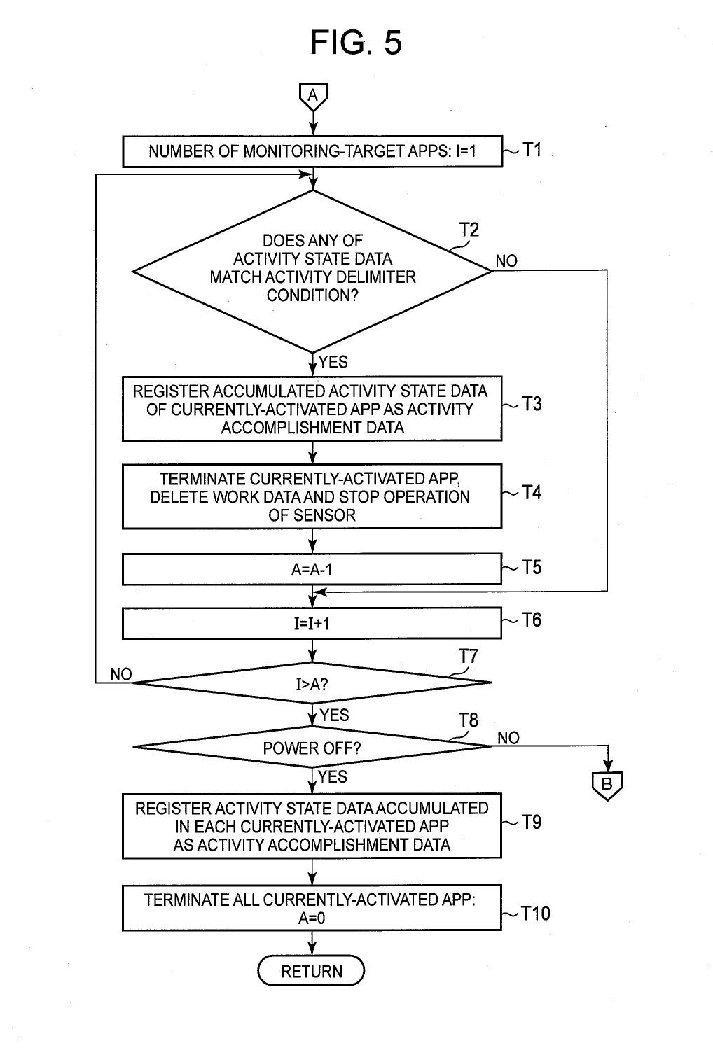

The data management processing program 40A is a program for causing the CPU 30 to execute a later-described data management processing (see FIG. 4 to FIG. 5).

In the memory 40, one category or a plural categories of applications are preset or downloaded to be installed therein. This embodiment describes about an example where App A (jogging app) 40B, App B (calorie consumption calculation app) 40C, and App C (cumulative ultraviolet quantity calculation app) 40D are installed as the applications. Incidentally, the applications can also be executed in response to an instruction received from an internet server (or network server) having an application function, without download of the applications. In this case, when specifying the user-intended application server, various pieces of data (later-described a category of activity state data, data of a condition for forming activity delimiter, etc.) necessary for executing the applications are set in a main body of the wrist terminal 10 or the mobile phone 20, and make them operate.

In this embodiment, each of the applications is correlated to each of the sensors on a one-to-one basis, and when the application is activated, the corresponding sensor operates, and detection results of the sensor are accumulated in the memory 40 as activity state data.

For example, in the case that App A (jogging app) 40B and App B (calorie consumption calculation app) 40C are installed as the applications as this embodiment, when App A (jogging app) 40B is activated, the position sensor 34 operates, and detection results (GPS data) of the position sensor 34 are accumulated as activity state data 1; 40E. When App B (calorie consumption calculation app) 40C is activated, the acceleration sensor 36 operates, and detection results (acceleration sensor data) of the acceleration-sensor 36 are accumulated as activity state data 2; 40F.

Furthermore, in this embodiment, with respect to categories of the application and the sensor, each of a category of activity state data to be accumulated and a condition for forming an activity delimiter in the activity state data is correlated on a one-to-one basis. When a certain application is activated, the category of the activity state data to be accumulated and the condition for forming the activity delimiter are set, as work data corresponding to the application, in the work area in the memory 40. The work data is set for each of the activated applications.

For example, when App B (calorie consumption calculation app) 40C is firstly activated, work data 40G is set. Specifically, activity state data 40G1 indicating that detection results (acceleration sensor data) of the acceleration sensor 36 are accumulated, and activity delimiter 40G2 indicating that an operating state of the acceleration sensor 36 is detected and the activity delimiter is formed in the activity state data 40G1 when fluctuation of acceleration has not been detected within a predetermined time period (for example, three minutes), are set.

When App A (jogging app) 40B is secondly activated, work data 40H is set. Specifically, active state data 40H1 indicating that detection results (GPS data) of the position sensor 34 are accumulated, and activity delimiter 40H2 indicating that an operating state of the position sensor 34 is detected and the activity delimiter is formed in the active state data 40H1 when position movement has not been detected within a predetermined time period (for example, three minutes), are set.

The wireless communication section 42 performs wireless communication with other communication devices (an internet 50, a personal computer/tablet terminal 52, etc.) Incidentally, as a wireless communication system, there can be used wireless LAN such as Wi-Fi communications which enable connecting to a network 60 via a Wi-Fi base station (access point) 62, portable communications which enable connecting to the network 60 via a portable base station 64, and so on.

The near field communication section 44 performs wireless communication with other communication devices (a personal computer/tablet terminal 52, etc.) Incidentally, as a wireless communication system, Bluetooth (registered trademark) or the like can be used, and this embodiment uses Bluetooth (registered trademark).

The CPU 30 centrally controls the respective sections of the wrist terminal 10 or the mobile phone 20.

Concretely, the CPU 30 expands a program specified from among system programs and various application programs which are stored in the memory 40 and executes various processes in cooperation with the expanded program.

### [Operation]

### <Data Management Processing>

Subsequently, data management processing executed by the wrist terminal 10 and/or the mobile phone 20 will be described with reference to the drawings.

FIG. 4 is flowchart for explaining about an operation of the data management processing.

Incidentally, this data management processing is executed by the CPU 30 in cooperation with the data management processing program 40A, when the wrist terminal 10 and/or the mobile phone 20 are activated and the data management processing program 40A is read out from the memory 40 to be expanded suitably.

As illustrated in FIG. 4, the CPU 30 firstly sets the number of categories of the currently-activated applications to zero (“0”) as a default setting (Step S1), and judges whether or not any of the applications has been activated by a user operation (Step S2).

When the application has been activated by a user operation (Step S2; YES), the CPU 30 specifies the category of the activated application and add one (“1”) to the number of categories of currently-activated applications (Step S3), and sets the activity state data and the activity delimiter which correspond to the application currently activated, as the work data thereof (Step S4).

“The activity state data” means data indicating an activity state of a user, and specifically means a detection result of the sensor corresponding to the category of the application. “The activity delimiter” means a delimiter/delimiters which forms/form divisions in the activity state data, and is/are formed on the basis of the detection result of the sensor corresponding to the category of the application.

For example, in the case that the calorie consumption calculation app 40C is activated as the currently-activated application, the CPU 30 performs setting for indicating that the detection results of the acceleration sensor 36 are accumulated as the activity state data 40F, and performs setting for indicating that the activity delimiter is formed in the activity state data 40F when the operating state of the acceleration sensor 36 is detected and fluctuation of acceleration has not been detected within a time period of three minutes.

Then, the CPU 30 judges whether or not the sensor corresponding to the currently-activated application is currently operating (Step S5).

When the sensor is already operating (Step S5; YES), the CPU 30 causes the memory 40 to accumulate the activity state data (Step S6). When the sensor is not operating yet (Step S5; NO), the CPU 30 causes the sensor to operate so that the memory 40 starts accumulating the activity state data (Step S7).

For example, in the case that the currently-activated application is the calorie consumption calculation app 40C, the CPU 30 judges whether or not the acceleration sensor 36 is currently operating, then causes the memory 40 to accumulate the detection results of the acceleration sensor 36 as the activity state data 40F when the acceleration sensor 36 is already operating, and causes the acceleration sensor 36 to operate so that the detection results of the acceleration sensor 36 are accumulated as the activity state data 40F when the acceleration sensor 36 is not operating yet.

When judging that the application has not been activated after Step S6 or S7, or in Step S2 (Step S2; NO), the CPU 30 judges whether or not the currently-activated application exists (Step S8), and repeats processes of Steps S2 to S7 until all currently-activated applications are terminated (Step S8; YES).

When the currently-activated application exists in Step S8 (Step S8; NO), as illustrated in FIG. 5, in order to continue to monitor the currently-activated application, the CPU 30 specifies the category of monitoring-target application and sets the number of categories of the monitoring-target applications to “1” (Step T1).

After that, the CPU 30 judges whether or not each piece of the activity state data of the applications, which has been accumulated by the accumulation unit correspondingly to the currently-activated application, matches the corresponding activity delimiter condition, on the basis of the detection result of the sensor corresponding to the currently-activated application (Step T2).

For example, in the case that the currently-activated application is the calorie consumption calculation app 40C, the CPU 30 judges whether fluctuation of acceleration has not been detected by the acceleration sensor 36 within a time period of three minutes.

When judging that any one piece of the activity state data matches the corresponding activity delimiter condition in Step T2 (Step T2; YES), the CPU 30 adds a completion mark to the activity state data accumulated in the process of Step S6 or S7, and registers it in the wrist terminal 10 or the mobile phone 20 (memory 40) as a series of pieces of activity accomplishment data. In the case of the application having a system by which the activity accomplishment data are managed in a server, the activity state data accumulated in the process of Step S6 or S7 are uploaded to the external communication devices 50, 52 to be registered therein as the activity accomplishment data, via the wireless communication section 42 or the near field communication section 44 (Step T3).

Then, the CPU 30 terminates the currently-activated application, and stops the operation of the sensor corresponding to the terminated application (Step T4).

For example, in the case that the currently-activated application is the calorie consumption calculation app 40C, the CPU 30 terminates the calorie consumption calculation app 40C, and stops the operation of the acceleration sensor 36.

After that, the CPU 30 subtracts “1” from the number of categories of the currently-activated applications (Step T5).

When judging that any of the activity state data does not match the corresponding activity delimiter condition in Step T2 (Step T2; NO), or after Step T5, the CPU 30 adds “1” to the number of categories of the monitoring-target applications (Step T6).

Incidentally, when there is no change in the categories of the monitoring-target applications, the CPU 30 shifts to Step T7 without executing the process of Step T6.

Then, the CPU 30 compares the number of categories of the currently-activated applications with the number of categories of the monitoring-target applications (Step T7), and repeats the processes of Steps T2 to T6 until the number of categories of the currently-activated applications becomes less than the number of categories of the monitoring-target applications (Step T7; NO).

When the number of categories of the currently-activated applications becomes less than the number of categories of the monitoring-target applications in Step T7 (Step T7; YES), the CPU 30 judges whether or not a power (power source) is turned off by a user operation (Step T8), and repeats the processes of Steps S2 to S8 and Steps T1 to T7 until the power is turned off (Step T8; NO).

When the power is turned off by a user operation in Step T8 (Step T8; YES), the CPU 30 adds the completion mark to the activity state data accumulated in each of the currently-activated applications, and registers it in the wrist terminal 10 or the mobile phone 20 (memory 40) as a series of pieces of the activity accomplishment data. In the case of the application having the system by which the activity accomplishment data are managed in the server, the activity state data accumulated in each of the currently-activated applications are uploaded to the external communication devices 50, 52 to be registered therein as the activity accomplishment data via the wireless communication section 42 or the near field communication section 44 (Step T9), terminates all of the currently-activated applications, returns the number of categories of the currently-activated applications to “0”, deletes all of the work data, and stops all of the operations of the sensors (Step T10).

### [Operation Example]

Subsequently, an operation example of the case that a plurality of categories of applications are activated and the above data management processing is repeatedly performed, namely is loop processing, will be described.

For example, when the calorie consumption calculation app 40C is activated by a user operation while the user stays at his/her home (Step S2; YES), settings are performed for indicating that the detection results of the acceleration sensor 36 are accumulated as the activity state data 40F and that the activity delimiter is formed in the activity state data 40F when fluctuation of acceleration has not been detected during a time period of three minutes (Step S4), and the acceleration sensor 36 actually operates and a calorie consumption amount of a user in his/her home is accumulated (Step S7).

After that, when the user starts jogging and the jogging app 40B is activated with that (Step S2; YES), settings are performed for indicating that the detection results of the position sensor 34 are accumulated as the activity state data 40E and that the activity delimiter is formed in the activity state data 40E when position movement has not been detected during a time period of three minutes (Step S4), and the position sensor 34 actually operates and running records of a user are accumulated (Step S7).

When jogging of the user has been terminated and the position movement has come to be not detected in the position sensor 34 during a time period of three minutes (Step T2; YES), the completion mark is added to the activity state data 40E accumulated as the running records, and the activity state data 40E to which the completion mark has been added is registered in the wrist terminal 10 or the mobile phone 20 (memory 40) as a series of pieces of the activity accomplishment data. In the case of the application having the system by which the activity accomplishment data are managed in the server, the activity state data 40E accumulated as the running records are automatically uploaded to the internet server 50 and/or the personal computer/tablet terminal 52 to be registered therein as the activity accomplishment data (Step T3), the jogging app 40B is terminated, and the operation of the position sensor 34 is stopped (Step T4). Incidentally, in the case of a GPS position sensor, though the position thereof randomly fluctuates mainly in a particular position due to errors even when the sensor stops, program processing recognizes the position as not moving. Moreover, in the case of receiving the instruction directly from the internet server and operating by the application, the instruction to terminate the application is transmitted to the internet server, communication connection with the main body of the wrist terminal 10 and/or the mobile phone 20 is terminated, and application processing in the main body is terminated.

Even in such case, the calorie consumption calculation app 40C continues to be activated and the acceleration sensor 36 continues to operate as long as fluctuation of acceleration continues to be detected in the acceleration sensor 36 (Step T2; NO), and as a result, also a calorie consumption amount during or around jogging of a user continues to be accumulated (Step S6).

After that, when the wrist terminal 10 and the mobile phone 20 are left (left at rest) after a user comes home, and when fluctuation of acceleration has come to be not detected during a time period of three minutes in the acceleration sensor 36 (Step T2; YES), the completion mark is added to the activity state data 40F accumulated as the calorie consumption amount which has been obtained during the period from the time of staying at home to that time, namely after the jogging, and the activity state data 40F to which the completion mark has been added are registered in the wrist terminal 10 or the mobile phone 20 (memory 40) as a series of activity accomplishment data. In the case of the application having a system that manages the activity accomplishment data in the server, the activity state data 40F accumulated as the running records are automatically uploaded to the internet server 50 and/or the personal computer/tablet terminal 52 to be registered therein as the activity accomplishment data (Step T3), the calorie consumption calculation app 40C is terminated, and also the operation of the acceleration sensor 36 is stopped (Step T4).

According to the above embodiment, as illustrated in Steps T2 to T3 of FIG. 5 and the like, whether or not the accumulated activity state data matches the activity delimiter condition is judged on the basis of the detection result of the sensor, and when it meets the activity delimiter condition, the activity state data accumulated until then are registered in the mobile phone, or uploaded to the external communication devices 50, 52 to be registered therein, as the activity accomplishment data. This can automatically subdivides outputting of data, and thereby power consumption associated with communication can be reduced, electricity can be saved, and a battery life can be lengthened in comparison with the case that the activity state data continues to be accumulated and are uploaded in a lump.

For example, in the case that running records are accumulated in the mobile phone as the activity state data of a user during his/her jogging, when the position movement is recognized as approximately having stopped on the basis of the detection result of the position sensor 34, jogging is judged as being terminated (or on a break) at that time, and the running records until then are automatically registered in the mobile phone or uploaded to the external communication devices 50, 52 to be registered therein. By this, power consumption associated with communication processes requiring large power consumption can be decreased as much as possible, electricity can be saved, and a battery life can be lengthened.

Moreover, as illustrated in Steps T3 to T4 of FIG. 5 and the like, the currently-activated application is forcibly terminated and also the operation of the sensor is stopped, after the activity state data in the mobile phone are registered, or after they are uploaded to be registered. By this, power consumption can be further reduced. In other words, it is possible to avoid the case that a user forgets to terminate the application and the sensor continues to operate, and thereby unnecessary data are accumulated.

Furthermore, as illustrated in Step S3 of FIG. 4, Steps T5 to T7 of FIG. 5 and the like, the category of the currently-activated application, the number of categories of the currently-activated applications, the category of the monitoring-target application, and the number of categories of the monitoring-target application are specified, and data management processing is executed to each category of application. Thus, in the case that a plurality of categories of applications are activated, only any of the applications is selectively terminated depending on the activity state of a user, and thereby electricity can be saved and a battery life can be lengthened more delicately.

For example, as illustrated in the operation example, in the case that the jogging app 40B and the calorie consumption calculation app 40C are activated as the applications and the position sensor 34 and the acceleration sensor 36 operate, when there is not a certain amount of movement of a user, it is judged that only the activity state data 40E corresponding to the jogging app 40B matches the activity delimiter condition, and then only the jogging app 40B is terminated and the operation of the position sensor 34 is stopped. The calorie consumption calculation app 40C continues to be activated as long as there is a subtle movement of a user, and when the state that acceleration is not detected at all has been maintained during a predetermined time period, that time point is judged as the activity delimiter of the activity state of that day, the calorie consumption calculation app 40C is terminated, and also the operation of the acceleration sensor 36 is stopped. By performing such processing depending on the activity state of a user, electricity can be saved and a battery life can be lengthened more delicately.

Incidentally, it is a matter of course that the detailed configurations and the detailed operations of the wrist terminal 10 and/or the mobile phone 20 according to the above embodiment can be arbitrary changed without departing from the spirit of the present invention.

For example, the mobile phone of the present invention may be worn on a wrist or an arm of a user, but it does not always need to be worn directly on a body of a user as long as it is carried with the user while being housed in his/her cloths, a bag, etc.

In addition, the category of the application and/or the sensor corresponding thereto can be arbitrary added/changed. For example, the cumulative ultraviolet quantity calculation app 40D which calculates a cumulative ultraviolet quantity may be installed in the memory 40 as the application (see FIG. 3), and an ultraviolet sensor can be mounted on the mobile phone as the sensor corresponding thereto. In this case, it is possible to judge whether or not the activity state data matches the activity delimiter condition on the basis of the detection results of the ultraviolet sensor throughout a time period in which a user spends time indoors or spends time outdoors, and thereby the activity state (cumulative amount of ultraviolet with which a user has been irradiated) of the user of the day can be known.

Although the embodiment of the present invention are described above, the scope of the present invention is not limited to the above embodiment, and includes the scope of the invention described in the claims and equivalents thereof.

What is claimed is:

1. A portable terminal comprising:
an activity delimiter condition storage unit in which a category of activity state data and an activity delimiter condition with respect to the activity state data are stored, for each of a plurality of categories of applications;
a detection unit that detects the activity state data, for each of the plurality of categories of applications;
an accumulation unit that accumulates the activity state data detected by the detection unit;
a judgment unit that judges whether or not each piece of the activity state data of the applications accumulated by the accumulation unit matches the corresponding activity delimiter condition; and
an activity accomplishment registration unit that registers, when the judgment unit judges that any one piece of the activity state data accumulated by the accumulation unit matches the corresponding activity delimiter condition, the one piece of the activity state data accumulated by the accumulation unit as an activity accomplishment data.

2. The portable terminal according to claim 1, wherein
the activity accomplishment registration unit includes:
an output unit that outputs, when the judgment unit judges that any one piece of the activity state data matches the corresponding activity delimiter condition, the one piece of the activity state data to an external communication device as the activity accomplishment data.

3. The portable terminal according to claim 2, further comprising:
a termination unit that terminates the application corresponding to the one piece of the activity state data after the output unit outputs the one piece of activity state data.

4. The portable terminal according to claim 2, further comprising:
a stop unit that stops an operation of the detection unit for the application corresponding to the one piece of the activity state data after the output unit outputs the one piece of activity state data.

5. A method for managing data in a portable terminal equipped with a memory that stores a plurality of categories of applications, the method comprising the steps of:
storing a category of activity state data and an activity delimiter condition with respect to the activity state data, for each of the plurality of categories of the applications;
detecting the activity state data, for each of the plurality of categories of applications;
accumulating the detected activity state data;
judging whether or not each piece of the activity state data of the applications accumulated in the accumulating step matches the corresponding activity delimiter condition, on the basis of a detection result obtained in the detecting step; and
registering, when it is judged that any one piece of the activity state data accumulated in the accumulating step matches the corresponding activity delimiter condition, the one piece of activity state data accumulated in the accumulating step as an activity accomplishment data.

6. A non-transitory storage medium storing a data management processing program for a portable terminal equipped with a memory that stores a plurality of categories of applications, the program causing the portable terminal to function as:
an activity delimiter condition storage controlling unit that stores a category of activity state data and an activity delimiter condition with respect to the activity state data, for each of the plurality of categories of the applications, in the memory;
a detection unit that detects the activity state data, for each of the plurality of categories of applications;
an accumulation unit that accumulates the activity state data detected by the detection unit;
a judgment unit that judges whether or not each piece of the activity state data of the applications accumulated by the accumulating unit matches the corresponding activity delimiter condition, on the basis of a detection result of the detection unit; and
an activity accomplishment registration unit that registers, when the judgment unit judges that any one piece of the activity state data accumulated in the accumulating step matches the corresponding activity delimiter condition, the one piece of activity state data accumulated by the accumulating unit as an activity accomplishment data.
